(19) United States
(12) Patent Application Publication
(10) Pub. No.: US 2013/0323592 A1
(43) Pub. Date: Dec. 5, 2013

(54) BINDER FOR ELECTRODE OF LITHIUM BATTERY, AND ELECTRODE AND LITHIUM BATTERY CONTAINING THE BINDER

(71) Applicant: Samsung SDI Co., Ltd., Yongin-si (KR)

(72) Inventors: Beom-Wook Lee, Yongin-si (KR); Hye-Sun Jeong, Yongin-si (KR); Hye-Ran Lee, Yongin-si (KR)

(21) Appl. No.: 13/829,082

(22) Filed: Mar. 14, 2013

(30) Foreign Application Priority Data
May 31, 2012 (KR) 10-2012-0058808

(51) Int. Cl. H01M 4/62; H01M 10/052; C08L 9/00

(52) U.S. Cl. CPC H01M 4/622; C08L 9/00; H01M 10/052
USPC 429/217; 525/122

(57) ABSTRACT

A binder for an electrode of a lithium battery, an electrode including the binder, and a lithium battery including the binder. The binder includes an epoxy-phenolic resin and a rubber-based resin, and prevents deformation of an electrode even when expansion and contraction of an active material occur from charging and discharging operations of a lithium battery, and thus improves lifetime of the lithium battery.

### CLAIM OF PRIORITY

This application makes reference to, incorporates the same herein, and claims all benefits accruing under 35 U.S.C. §119 from an application for BINDER FOR ELECTRODE OF LITHIUM BATTERY, AND ELECTRODE AND LITHIUM BATTERY CONTAINING THE BINDER earlier filed in the Korean Intellectual Property Office on 31 May 2012 and there duly assigned Serial No. 10-2012-0058808.

### BACKGROUND OF THE INVENTION

1. Field of the Invention

The present invention relates to a binder for an electrode of a lithium battery, and an electrode and a lithium battery that includes the binder.

2. Description of the Related Art

Lithium secondary batteries used in portable electronic devices for information communication, such as personal data assistants (PDAs), mobile phones, and laptop computers, electric bicycles, electric vehicles, and the like have a higher discharge voltage that is about twice or more than that of existing batteries, and thus exhibit a higher energy density.

Lithium secondary batteries with a cathode and an anode, each including an active material that allows intercalation and deintercalation of lithium ions, and an organic electrolyte solution or a polymer electrolyte solution filling the gap between the cathode and the anode, produce electrical energy from redox reactions that take place as lithium ions are intercalated into or deintercalated from the cathode and the anode.

Lithium-transition metal oxides, such as lithium cobalt oxide (LiCoO₂), lithium nickel oxide (LiNiO₂), or lithium nickel cobalt manganese oxide (Li(NiCoMn)O₂, LiNi_{1-x-y}CoₓMn_{y}O₂ (0<x<1, 0<y<1 and 0<x+y<1)), having a structure that allows intercalation of lithium ions may be used as cathode active materials for lithium secondary batteries.

Carbonaceous materials in various forms, such as artificial graphite, natural graphite, and hard carbon, which allow intercalation and deintercalation of lithium ions, and non-carbonaceous materials such as silicon (Si) have been studied for use as anode active materials.

Such non-carbonaceous materials exhibit a very high capacity density that is ten times or more than that of graphite. However, since volumetric expansion and contraction of the non-carbonaceous materials during charging and discharging of lithium batteries are more severe than when using carbonaceous materials, the use of the non-carbonaceous materials has limitations in implementing a desired capacity.

To address these drawbacks, there has been intensive research into high-capacity active materials as described above, and into other components of the lithium batteries, such as a cathode active material, an electrolyte, a separator, and a binder, to improve characteristics of each component of the lithium batteries.

### SUMMARY OF THE INVENTION

One or more embodiments of the present invention may include a binder for an electrode of a lithium battery that may improve lifetime characteristics of lithium secondary batteries.

One or more embodiments of the present invention may include an electrode including the binder, for a lithium battery.

One or more embodiments of the present invention may include a lithium battery including the binder.

Additional aspects will be set forth in part in the description which follows and, in part, will be apparent from the description, or may be learned by practice of the presented embodiments.

According to one or more embodiments of the present invention, a binder for an electrode of a lithium battery may include an epoxy-phenolic resin and a rubber-based resin.

In some embodiments of the present invention, an amount of the rubber-based resin may be from about 1 part by weight to about 300 parts by weight based on 100 parts by weight of the epoxy-phenolic resin.

In some embodiments of the present invention, the epoxy-phenolic resin may be made from an epoxy-based resin, a multi-functional phenolic resin, and a curing agent.

In some embodiments of the present invention, the epoxy-based resin may include at least one selected from the group consisting of bisphenol-A epoxy resin, bisphenol F epoxy resin, bisphenol S epoxy resin, bisphenol epoxy resin, phenolic novolac epoxy resin, cresol novolac epoxy resin, bisphenol-A novolac epoxy resin, bisphenol F novolac epoxy resin, phenolic salicylaldehyde novolac epoxy resin, alicyclic epoxy resin, aliphatic chain epoxy resin, glycidyl ester epoxy resin, a glycidyl-etherification product of bifunctional phenol, a glycidyl-etherification product of bifunctional alcohol, a glycidyl-etherification product of polyphenol, and a modified resin thereof.

In some embodiments of the present invention, the multi-functional phenolic resin may include at least one selected from the group consisting of bisphenol F, bisphenol-A, bisphenol S, polyvinyl phenol, phenol, cresol, alkyl phenol, catechol, novolac resin, and a halide substitution product thereof.

In some embodiments of the present invention, the curing agent may include at least one selected from the group consisting of an alkali metal compound, an alkali earth metal compound, an imidazole compound, an organic phosphorous compound, and an amine-based compound.

In some embodiments of the present invention, an amount of the multi-functional phenolic resin may be from about 1 part to about 300 parts by weight, and an amount of the curing agent may be from about 0.01 parts to about 20 parts by weight, each based on 100 parts by weight of the epoxy-based resin.

In some embodiments of the present invention, at least one of the epoxy-based resin and the multi-functional phenolic resin may further include a carboxyl group.

In some embodiments of the present invention, the multi-functional phenolic resin may have a hydroxyl equivalent of from about 50 to about 1000.

In some embodiments of the present invention, the epoxy-phenolic resin may have an epoxy equivalent weight of from about 100 to about 2000.

In some embodiments of the present invention, the rubber-based resin may further include a cross-linking agent. In some embodiments of the present invention, an amount of the cross-linking agent may be from about 0.01 parts to about 30 parts by weight based on 100 parts by weight of the rubber-based resin.

In some embodiments of the present invention, the binder may be used in forming an anode of a lithium battery.

According to one or more embodiments of the present invention, an electrode for a lithium battery may include the above-described binder.

According to one or more embodiments of the present invention, a lithium battery may include an anode; a cathode disposed opposite to the anode; and an electrolyte disposed between the anode and the cathode, wherein at least one of the anode and the cathode may include the above-described binder.

In some embodiments of the present invention, the anode may include at least one anode active material selected from among a silicon-based active material, a tin-based active material, a silicon-tin alloy-based active material, and a silicon-carbon-based active material.

### BRIEF DESCRIPTION OF THE DRAWING

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a schematic perspective view of a lithium battery according to an embodiment of the present invention;

### DETAILED DESCRIPTION OF THE INVENTION

Hereinafter, the preset invention will be described more fully with reference to the accompanying drawings. Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

As used herein, the term “and/or” includes any and all combinations of one or more of the associated listed items. Expressions such as “at least one of,” when preceding a list of elements, modify the entire list of elements and do not modify the individual elements of the list.

According to an embodiment of the present invention, a binder for an electrode of a lithium battery may include an epoxy-phenolic resin and a rubber-based resin.

The binder for an electrode of a lithium battery may be used, in particular, in forming an anode of a lithium battery. The electrode may use a high-capacity anode active material such as silicon-based active materials, tin-based active materials, silicon-tin alloy-based active materials, and silicon-carbon-based active materials, as well as graphite-based active materials.

Since the binder includes an epoxy-phenolic resin that provides adhesion and tensile strength, and a rubber-based resin providing elasticity, the electrode using the binder may have strong adhesion and tensile strength with respect to an active material and a current collector, and improved elasticity and thus is unlikely to be deformed even when expansion and contraction of the active material occur from charging and discharging operation of a lithium battery. Therefore, the lifetime of the lithium battery may be improved.

The epoxy-phenolic resin used in the binder provides improved adhesion to an active material and a current collector and tensile strength to the anode. In some embodiments, the epoxy-phenolic resin may be made from an epoxy-based resin, a multi-functional phenolic resin, and a curing agent.

Non-limiting examples of the epoxy-based resin of the epoxy-phenolic resin may include bisphenol-A epoxy resin, bisphenol F epoxy resin, bisphenol S epoxy resin, bisphenol epoxy resin, phenolic novolac epoxy resin, cresol novolac epoxy resin, bisphenol-A novolac epoxy resin, bisphenol F novolac epoxy resin, phenolic salicylaldehyde novolac epoxy resin, alicyclic epoxy resin, aliphatic chain epoxy resin, glycidyl ester epoxy resin, a glycidyl-etherification product of bifunctional phenol, a glycidyl-etherification product of bifunctional alcohol, a glycidyl-etherification product of polyphenol, and a modified resin thereof, which may be used alone or in combination of at least two thereof.

Non-limiting examples of the multi-functional phenolic resin of the epoxy-phenolic resin are Novolac resin obtained by reaction of phenol, such as bisphenol F, bisphenol-A, bisphenol S, polyvinyl phenol, phenol, cresol, alkyl phenol (for example, p-t-butylphenol and p-octylphenol), catechol, bisphenol F, bisphenol-A, or bisphenol S, with an aldehyde, such as formaldehyde and acetaldehyde, in the presence of an acidic catalyst; and a halide substituent thereof, which may be used alone or in combination of at least two thereof.

The multi-functional phenolic resin may have a hydroxyl equivalent weight of from about 50 to about 1000. When the hydroxyl equivalent weight of the multi-functional phenolic resin is within this range, a cross-linking reaction may be facilitated.

In some embodiments, an amount of the multi-functional phenolic resin may be from about 1 part to about 300 parts by weight based on 100 parts by weight of the epoxy-based resin. For example, the amount of the multi-functional phenolic resin may be from about 10 parts to 200 parts by weight, and in some embodiments, may be from about 20 parts to about 100 parts by weight, both based on 100 parts by weight of the epoxy-based resin. When the amount of the multi-functional phenolic resin is within these ranges, the lithium battery may have improved lifetime without a reduction in adhesion and tensile strength with respect to the active material and current collector.

In some embodiments, at least one of the epoxy-based resin and the multi-functional phenolic resin may further include a carboxyl group. This may contribute to improving adhesion to the current collector and dispersion stability of slurry. The details about the slurry will be explained in Examples.

In some embodiments, as the curing agent in the epoxy-phenolic resin, a compound catalyzing a cross-linking reaction between the epoxy-based resin and the multi-functional phenolic resin is used. Non-limiting examples of the curing agent may be an alkali metal compound, an alkali earth metal compound, an imidazole compound, an organic phosphorous compound, and an amine-based compound (for example, a secondary amine, a tertiary amine, a quaternary ammonium salt, or polyamine), which may be used alone or in combination of at least two thereof.

In some embodiments, an amount of the curing agent may be from about 0.01 parts to about 20 parts by weight based on 100 parts by weight of the epoxy-based resin. In some embodiments, an amount of the curing agent may be from about 0.01 parts to about 10 parts by weight, and in some other embodiments, an amount of the curing agent may be from about 0.1 parts to about 5 parts by weight, both based on 100 parts by weight of the epoxy-based resin. When the amount of the curing agent is within these ranges, sufficient thermal curing reaction (crossing-linking reaction) may occur. Therefore, desired characteristics may be obtained, and storage stability of the epoxy-phenolic resin may be ensured.

The epoxy-phenolic resin with the above-described composition may have an epoxy equivalent weight of from about 100 to about 2000. A sufficient cross-linking reaction may occur within this range of the epoxy equivalent of the epoxy-phenolic resin.

In some embodiments, the rubber-based resin of the binder is an elasticity component of the binder, may further include a cross-linking agent depending on a degree of elasticity of the rubber-based resin.

Non-limiting examples of the rubber-based resin are natural rubber, butadiene rubber, styrene-butadiene rubber, chloroprene rubber, nitrile rubber, butyl rubber, ethylene-propylene rubber, acryl rubber, urethane rubber, fluororubber, and/or a modified rubber thereof, which may be used alone or in combination of at least two thereof. Non-limiting examples of the modified rubber of butadiene rubber are epoxy-modified butadiene rubber, urethane-modified butadiene rubber, acrylonitrile-modified butadiene rubber, carboxyl group-containing butadiene rubber, carboxyl group-containing methacrylonitrile butadiene rubber, acryl group-containing butadiene rubber, and/or hydroxyl group-containing butadiene rubber.

In some embodiments, an amount of the rubber-based resin may be from about 1 part by weight to about 300 parts by weight based on 100 parts by weight of the epoxy-phenolic resin. In some embodiments, the rubber-based resin may be from about 10 parts by weight to about 200 parts by weight, and in some other embodiments, may be from about 50 parts by weight to about 100 parts by weight, both based on 100 parts by weight of the epoxy-phenolic resin. When the amount of the rubber-based resin is within these ranges, it may provide elasticity to the binder and improve lifetime of the lithium battery, and the rubber-based resin may have improved storage stability.

In some embodiments, the cross-linking agent may induce cross-linking of the rubber-based resin, thereby increasing elasticity of the rubber-based resin. An amount and composition of the cross-linking agent are dependent on the degree of elasticity of the rubber-based resin.

Non-limiting examples of the cross-linking agent are sulfur, organo-sulfur, peroxide, and/or an amine-based compound. Non-limiting examples of peroxides mostly used as the cross-linking agent are acyl peroxides, such as benzoyl peroxide, 2,4-dichlorobenzoylperoxide, and p-chlorobenzoyl peroxide; and/or alkyl peroxides, such as dicumylperoxide, di-t-butyl peroxide, 2,5-dimethyl-2,5-di-t-butylhexane peroxide, and t-butylcumyl peroxide, wherein these listed peroxides may be used alone or in combination of at least two thereof.

In some embodiments, an amount of the cross-linking agent is from about 0.01 parts by weight to about 30 parts by weight based on 100 parts by weight of the rubber-based resin. In some embodiments, the amount of the cross-linking agent may be from about 0.01 parts by weight to about 20 parts by weight, and in some other embodiments, may be from about 0.01 parts by weight to about 10 parts by weight, both based on 100 parts by weight of the rubber-based resin. When the amount of the cross-linking agent is within these ranges, the rubber-based resin may have increased elasticity and improved storage stability.

In some embodiments, the binder for an electrode of a lithium battery may further include an additive, if required, for improvement in characteristics of the binder. Examples of the additive are a thickening agent, a conducting agent, a filler, a coupling agent, and an adhesion promoter. These additives may be used as a mixture with or a separate form from the other binder components described above in preparing binder slurry for forming an electrode of a lithium battery. An appropriate additive with a composition may be selected depending on the composition of the binder. An additive may be not be used if required. An amount of the additive may be dependent on the composition of the binder and the type of additive selected. The amount of the additive may be from about 0.01 parts by weight to about 10 parts by weight based on 100 parts by weight of the binder. The additive may provide a desired effect within this range.

The thickening agent may be added when the binder slurry has a low viscosity, in order to facilitate coating of the binder slurry on a current collector. Non-limiting examples of the thickening agent are carboxymethyl cellulose, carboxyethyl cellulose, ethyl cellulose, hydroxymethyl cellulose, hydroxyethyl cellulose, hydroxypropyl cellulose, and/or polyvinylalcohol, which may be used alone or in combination of at least two thereof.

The conducting agent may be used to provide conductivity to an electrode. Any electron conducting material that does not induce chemical change in batteries may be used. Non-limiting examples of the conducting agent are natural graphite, artificial graphite, carbon black, acetylene black, and ketjen black; metallic materials, such as copper, nickel, aluminum, and silver in powder form; and conducting materials such as polyphenylene derivatives, wherein these conducting agents may be used alone or in combination of at least two thereof.

The filler may assist improving strength of the binder to suppress the expansion of an electrode. The filler may be a fibrous material, such as glass fiber, carbon fiber, or metal fiber.

The coupling agent may assist increasing the adhesion between an electrode active material and a binder. The component of the coupling agent may be a material with at least two functional groups, one to bind to the active material, and the other to bind to the binder. For example, the coupling agent may be a silane-based coupling agent commonly used in the art.

The adhesion promoter may assist improving the adhesion of an active material to a current collector in an electrode. Non-limiting examples of the adhesion promoter are oxalic acid, adipic acid, formic acid, acrylic acid derivatives, and itaconic acid derivatives.

The binder for an electrode of a lithium battery may be mixed with a solvent when preparing electrode slurry. Non-limiting examples of the solvent include N,N-dimethylformamide, N,N-dimethylacetamide, methylethylketone, cyclohexanone, acetic acidethyl, acetic acidbutyl, cellosolveacetate, propyleneglycol monomethylether acetate, methylcellosolve, butylcellosolve, methylcarbitol, butylcarbitol, propyleneglycol monomethylether, diethyleneglycol dimethylether, toluene, and xylene, which may be used alone or in combination of at least two thereof. An amount of the solvent is not specifically limited, and may be determined to obtain slurry with an appropriate viscosity.

An electrode manufactured using the above-described binder for a lithium battery, which includes an epoxy-phenolic resin providing adhesion and tensile strength, and a rubber-based resin providing elasticity, may have strong adhesion with respect to active material and current collector, and elasticity, and thus is unlikely to be deformed when the expansion and contraction of the active material occur from charging and discharging operations of the lithium battery, so that the lithium battery may have improved lifetime. In particular, the binder is durable against a large volumetric change of a high-capacity anode active material. The anode active material may include a silicon-based active material, a tin-based active material, a silicon-tin alloy-based active material, and a silicon-carbon-based active material, and may be suitable for use in an anode using such a high-capacity anode active material.

According to another embodiment of the present invention, a lithium battery may includes an anode; a cathode disposed opposite to the anode; and an electrolyte disposed between the anode and the cathode, wherein at least one of the anode and cathode may includes the binder.

In an embodiment, an anode may include the above-described binder.

In some embodiments, the anode may include an anode active material. The anode may be prepared by preparing an anode active material composition as a mixture of an anode active material, a binder, and an optional conducting material, and a solvent, and then molding the anode active material composition in a predetermined shape, or coating a current collector such as a copper foil.

The anode active material may be any of a variety of anode active materials commonly used in the art, and are not specifically limited. Non-limiting examples of the anode active material may be lithium metal, a metal that is alloyable with lithium, a transition metal oxide, a material that allows doping or undoping of lithium, and a material that allows reversible intercalation and deintercalation of lithium ions, which may be used as a mixture or in a combination of at least two thereof.

Non-limiting examples of the transition metal oxide may be a tungsten oxide, a molybdenum oxide, a titanium oxide, a lithium titanium oxide, a vanadium oxide, and a lithium vanadium oxide.

Examples of the material that allows doping or undoping of lithium may include silicon (Si), SiO, wherein 0<x≦2, a Si—Y alloy wherein Y is an alkali metal, an alkali earth metal, a Group XIII element, a Group XIV element, a transition metal, a rare earth element, or combinations thereof (except for Si), Sn, SnO₂, a Sn—Y alloy wherein Y is an alkali metal, an alkali earth metal, a Group XIII element, a Group XIV element, a transition metal, a rare earth element, or a combination thereof (except for Sn), and combinations of at least one of these materials and SiO₂. Y may be magnesium (Mg), calcium (Ca), strontium (Sr), barium (Ba), radium (Ra), scandium (Sc), yttrium (Y), titanium (Ti), zirconium (Zr), hafnium (Hf), rutherfordium (RD, vanadium (V), niobium (Nb), tantalum (Ta), dubnium (Db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), tin (Sn), indium (In), titanium (Ti), germanium (Ge), phosphorus (P), arsenic (As), antimony (Sb), bismuth (Bi), sulfur (S), selenium (Se), tellurium (Te), polonium (Po), or combinations thereof.

The material that allows reversible intercalation and deintercalation of lithium ions may be any carbonaceous negative active material that is commonly used in a lithium battery. Examples of such carbonaceous materials may be crystalline carbon, amorphous carbon, and/or mixtures thereof. Non-limiting examples of the crystalline carbon may be natural graphite and artificial graphite that are in amorphous, plate, flake, spherical or fibrous form. Non-limiting examples of the amorphous carbon may be soft carbon (carbon sintered at low temperatures), hard carbon, meso-phase pitch carbides, and sintered cork.

In some embodiments, the anode active material may be any of a variety of high-capacity active materials: for example, silicon-based active materials, such as Si, SiO, (0<x≦2), and a Si—Y alloy; tin-based active materials, such as Sn, SnO₂, and a Sn—Y alloy; silicon-tin alloy-based active materials, and silicon-carbon-based active materials.

The binder of an anode active material composition may assist binding of the anode active material and the conducting agent, and binding of the anode active material composition to the current collector. In an embodiment, the binder including the epoxy-phenolic resin and the rubber-based resin as described above may be used to suppress the volumetric expansion of the anode active material that may occur during charging and discharging of lithium in a lithium battery. In some embodiments, an amount of the binder may be from about 1 part by weight to about 20 parts by weight, and in some other embodiments, may be from about 2 parts by weight to about 10 parts by weights, both based on 100 parts by weight of the anode active material.

The anode active material composition may include one of the above-described binders alone, and in some embodiments, may use a mixture of at least two of the above-described binders to improve adhesion between the current collector and active material, and tensile strength and elasticity of the anode. In some other embodiments, to improve characteristics of the anode, a mixture of the above-described binder and a common binder not including an epoxy-phenolic resin and a rubber-based resin may be used. The common binder used together for the improvement of the characteristics may not be specifically limited, provided that the common binder is miscible with the above-described binder, the active material, and other additives, and is electrochemically stable during charging and discharging operations. Non-limiting examples of the common binder may be polyvinylidene fluoride (PVDF), polyvinyl alcohols, carboxymethyl cellulose (CMC), starch, hydroxypropyl cellulose, regenerated cellulose, polyvinylpyrrolidone, tetrafluoroethylene, polyethylene, polypropylene, ethylene-propylene-diene terpolymer (EPDM), sulfonated EPDM, styrene butadiene rubber, fluoro rubber, and various copolymers, which may be used in combination thereof.

The anode for a lithium battery may further include a conducting agent (i.e. conducting materials). The conducting agent may be any one commonly used in lithium batteries. Non-limiting examples of the conducting agent may be carbonaceous materials, such as natural graphite, artificial graphite, carbon black, acetylene black, ketjen black, carbon fibers (for example, vapor-phase grown carbon fiber), and the like; metal-based materials, such as copper, nickel, aluminum, silver, and the like, in powder or fiber form; and conductive materials, including conductive polymers, such as a polyphenylene derivative, and a mixture thereof. The amount of the conducting agent may be appropriately adjusted.

The amount of the solvent for forming the anode may be from about 10 parts by weight to about 300 parts by weight based on 100 parts by weight of the negative active material (i.e. anode active material). When the amount of the solvent is within this range, forming the anode active material layer may be facilitated.

The anode active material composition may further include other additives, if required, for example, an adhesion enhancer, such as a silane coupling agent, for improving adhesion between the current collector and active material; and a dispersing agent for improving dispersion of the slurry.

In addition, the current collector is generally fabricated to have a thickness of about 3 to about 100 μm. The current collector is not particularly limited, and may be any of a variety of materials that have conductivity and cause no chemical change in the fabricated battery. Non-limiting examples of the current collector may be copper, stainless steel, aluminum, nickel, titanium, sintered carbon, copper or stainless steel that is surface-treated with carbon, nickel, titanium, or silver, and aluminum-cadmium alloys. In addition, the current collector may be processed to have fine irregularities on surfaces thereof so as to enhance the adhesion of the current collector to the anode active material, and may be used in any of various forms including films, sheets, foils, nets, porous structures, foams, and non-woven fabrics.

The anode active material composition may be coated directly on a current collector to manufacture an anode plate. Alternatively, the anode plate may be manufactured by casting the anode active material composition on a separate support to form an anode active material film, which may be separated from the support, and then laminated on a copper foil current collector. The anode is not limited to the above-described forms, and may be any of a variety of types.

Separately, in order to form a cathode, a cathode active material, a conducting agent, a binder, and a solvent are mixed together to prepare a cathode active material composition. The cathode may be prepared by the cathode active material composition.

Any lithium-containing metal oxide that is commonly used in the art may be used as the cathode active material. Non-limiting examples of the lithium-containing metal oxide may be LiCoO₂, LiMnₓO₂ₓ (where x=1 or 2), LiNi₁₋ₓMnₓO₂ (where 0<x<1), or LiNi_{1-x-y}CoₓMn_{y}O₂ (where 0≦x≦0.5 and 0≦y≦0.5). Non-limiting examples of the lithium-containing metal oxide may be compounds that allow intercalation and deintercalation of lithium ions, for example, LiMn₂O₄, LiCoO₂, LiNiO₂, LiFeO₂, LiFePO₄, V₂O₅, TiS, and/or MoS.

The conducting agent, the binder, and the solvent used in the anode active material composition described above may also be used in the cathode active material composition. If required, a plasticizer may be added to each of the cathode active material composition and the anode active material composition to form pores in the electrode plates. The amounts of the cathode active material, the conducting agent, the binder, and the solvent may be in ranges that are commonly used in lithium batteries.

A cathode current collector may be fabricated to have a thickness of from about 3 μm to about 100 μm, and may be any current collector having high conductivity without causing chemical changes in fabricated batteries. Non-limiting examples of the positive electrode current collector (i.e. cathode current collector) may be stainless steel, aluminum, nickel, titanium, sintered carbon, and aluminum or stainless steel that is surface-treated with carbon, nickel, titanium, or silver. The cathode current collector may be processed to have fine irregularities on a surface thereof so as to enhance the adhesion of the cathode current collector to the cathode active material composition. The cathode current collector may be in any of various forms, including a film, a sheet, a foil, a net, a porous structure, foam, and non-woven fabric.

The cathode active material composition is directly coated on the cathode current collector and dried to prepare the cathode electrode plate. Alternatively, the cathode active material composition may be cast on a separate support to form a cathode active material film, which is separated from the support and then laminated on the cathode current collector to prepare the cathode electrode plate.

The cathode and the anode may be separated from each other by a separator. Any separator that is commonly used for lithium batteries may be used. In particular, the separator may have low resistance to migration of lithium ions in an electrolyte and have a high electrolyte-retaining ability. Non-limiting examples of the separator may be glass fiber, polyester, Teflon, polyethylene, polypropylene, polytetrafluoroethylene (PTFE), and a combinations thereof, each of which may be a nonwoven fabric or a woven fabric. The separator may have a pore diameter of about 0.01 μm to about 10 μm and a thickness of about 3 μm to about 100 μm.

The electrolyte may be a lithium salt-containing non-aqueous electrolyte. The lithium salt-containing non-aqueous electrolyte may be composed of a non-aqueous electrolyte solution and a lithium salt. The non-aqueous electrolyte may be a non-aqueous liquid electrolyte, an organic solid electrolyte, or an inorganic solid electrolyte.

Non-limiting examples of the non-aqueous liquid electrolyte may be any of aprotic organic solvents such as N-methyl-2-pyrrolidone, propylene carbonate, ethylene carbonate (EC), butylene carbonate, dimethyl carbonate, diethyl carbonate (DEC), fluoroethylene carbonate (FEC), γ-butyrolactone, 1,2-dimethoxy ethane, tetrahydroxyfuran, 2-methyl tetrahydrofuran, dimethylsulfoxide, 1,3-dioxolane, formamide, dimethylformamide, acetonitrile, nitromethane, methyl formate, methyl acetate, phosphoric acid trimester, trimethoxy methane, dioxolane derivatives, sulfolane, methyl sulfolane, 1,3-dimethyl-2-imidazolidinone, propylene carbonate derivatives, tetrahydrofuran derivatives, ether, methyl propionate, and ethyl propionate.

Non-limiting examples of the organic solid electrolyte may be polyethylene derivatives, polyethylene oxide derivatives, polypropylene oxide derivatives, phosphoric acid ester polymers, poly agitation lysine, polyester sulfide, polyvinyl alcohols, polyvinylidene fluoride, and polymers containing ionic dissociation groups.

Non-limiting examples of the inorganic solid electrolyte may be nitrides, halides and sulfates of lithium such as Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, and Li₃PO₄—Li₂S—SiS₂.

The lithium salt may be any lithium salt that is commonly used in lithium batteries, and that is soluble in the above-mentioned lithium salt-containing non-aqueous electrolyte. For example, the lithium salt may include at least one selected from the group consisting of LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, lithium chloroborate, lower aliphatic carboxylic acid lithium, lithium tetraphenyl borate, and imide.

Lithium batteries may be classified as lithium ion batteries, lithium ion polymer batteries, or lithium polymer batteries, according to the type of separator and/or electrolyte included therein. In addition, lithium batteries may be classified as cylindrical type, rectangular type, coin type, or pouch type batteries, according to the shape thereof. Lithium batteries may also be classified as either bulk type or thin film type batteries, according to the size thereof. In addition, lithium primary batteries and lithium secondary batteries are available.

A method of manufacturing a lithium battery is widely known in the art, so a detailed description thereof will not be recited here.

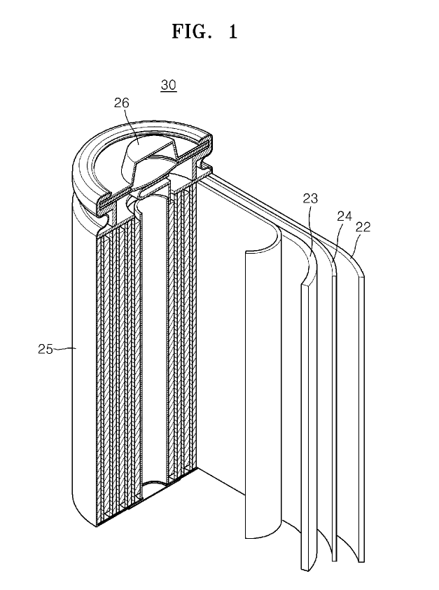

FIG. 1 is a schematic perspective view of a lithium battery according to an embodiment of the present invention.

Referring to FIG. 1, the lithium battery 30 includes a cathode 23, an anode 22, and a separator 24 disposed between the cathode 23 and the anode 22. The cathode 23, the anode 22, and the separator 24 are wound or folded, and then accommodated in a battery case 25. Subsequently, an electrolyte is injected into the battery case 25 and the battery case 25 is sealed by a sealing member 26, thereby completing the manufacture of the lithium battery 30. The battery case 25 may have a cylindrical shape, a rectangular shape or a thin-film shape. The lithium battery 30 may be a lithium ion battery.

The lithium battery may be suitable for use as power sources for electric vehicles and power tools requiring high capacity, high-power output, and operation under high temperature conditions, in addition to power sources for conventional mobile phones and portable computers, and may be coupled to conventional internal combustion engines, fuel cells, or super-capacitors to be used in hybrid vehicles. In addition, the lithium battery may be used in all applications requiring high-power output, high voltage, and operation under high temperature conditions.

One or more embodiments of the present invention will be described in detail with reference to the following examples. However, these examples are not intended to limit the scope of the one or more embodiments of the present invention.

### EXAMPLES

### 1. Preparation of Epoxy-Phenolic Resin Composition

1-1. Preparation of Epoxy-Phenolic Resin Composition A

6.0 g of bisphenol-A novolac epoxy resin (having an epoxy equivalent of about 200 to about 220) as an epoxy-based resin, 3.98 g of bisphenol-A novolac resin (having a hydroxyl equivalent of about 100 to about 120) as a multi-functional phenolic resin were dissolved in 90 g of xylene in a mixing vessel, followed by an addition of 0.02 g of 1-cyanoethyl-2-ethyl-4-methylimidazole as a curing agent to prepare an epoxy-phenolic resin composition A having about 10 wt % of solid content.

1-2. Preparation of Epoxy-Phenolic Resin Composition B

6.0 g of bisphenol-A epoxy resin (having an epoxy equivalent of about 800 to about 950) as an epoxy-based resin and 3.98 g of bisphenol-A novolac resin (having a hydroxyl equivalent of about 100 to about 120) as a multi-functional phenolic resin were dissolved in 90 g of xylene in a mixing vessel, followed by an addition of 0.02 g of 1-cyanoethyl-2-ethyl-4-methylimidazole as a curing agent to prepare an epoxy-phenolic resin composition B having about 10 wt % of solid content.

### 2. Preparation of Rubber-Based Resin Composition

9.5 g of butadiene rubber (having a cis content of about 95 to about 98%) as a rubber-based resin was dissolved in 90 g of xylene in a mixing vessel, following by an addition of 0.5 g of dicumylperoxide to prepare a rubber-based resin composition having about 10 wt % of solid content.

### 3. Preparation of Slurry for Anode of Lithium Battery

Slurries for anodes of lithium secondary batteries were prepared in the following methods using the resin compositions prepared in Sections 1 and 2 above.

3-1. Preparation of Slurry 1

8 g of the epoxy-phenolic resin composition A prepared in Section 1-1, and 2 g of a rubber-based resin composition prepared in Section 2 were agitated in a vessel for about 30 minutes to prepare a homogeneously mixed solution. 19 g of mixed powder of a Si—Ti—Ni-based Si-alloy (average particle diameter of about 5 μm) and graphite in a weight ratio of about 2:8 was added to the solution, and agitated for about 1 hour to homogeneously disperse the mixed powder, thereby preparing a slurry 1.

3-2. Preparation of slurry 2

A slurry 2 was prepared in the same manner as in the preparation of the slurry 1 (Section 3-1), except that the epoxy-phenolic resin composition B prepared in Section 1-2, instead of the epoxy-phenolic resin composition A used in the preparation of slurry 1, was used.

3-3. Preparation of slurry 3

A slurry 3 was prepared in the same manner as in the preparation of the slurry 1 (Section 3-1), except that 5 g of the epoxy-phenolic resin composition A and 5 g of a rubber-based resin composition were used.

3-4. Preparation of Comparative Slurry 1

A comparative slurry 1 was prepared in the same manner as in the preparation of the slurry 1 (Section 3-1), except that 10 g of the epoxy-phenolic resin composition A was used only as a binder composition.

3-5. Preparation of Comparative Slurry 2

A comparative slurry 2 was prepared in the same manner as in the preparation of the slurry 1 (Section 3-1), except that 10 g of the rubber-based resin composition was used only as a binder composition.

### 4. Manufacture of Electrode and Battery

Each of the anode active material slurries prepared in Sections 3-1 to 3-5 was coated on a copper foil, dried at about 110° C. for about 1 hour, and then dried again in a 150° C. vacuum oven for about 2 hours, followed by being pressed using a press, thereby manufacturing an anode. Lithium secondary batteries of Examples 1-3 and Comparative Examples 1-2 were manufactured using the resulting anodes and Li metal counter electrodes. A mixture of ethylene carbonate (EC) in which 1M LiPF₆ was dissolved and diethylene carbonate (DEC) at a volume ratio of 1:1 was used as an electrolyte.

Evaluation of Battery Characteristics

Initial formation efficiencies and lifetimes of the lithium secondary batteries manufactured in Examples 1-3 and Comparative Examples 1-2 were evaluated using a charging/discharging system.

A charge/discharge test was performed at a room temperature of about 25° C. The initial formation efficiency was measured after a cycle of 0.2 C charging/0.2 C discharging, and the lifetime was measured after 100 and 300 cycles of 0.5 C charging/0.5 C discharging. The initial formation efficiency was calculated using Equation 1 below, and the lifetime was calculated based on a capacity retention ratio defined by Equation 2.

Initial formation efficiency (%)=Discharge capacity of 1^{st} cycle/Charge capacity of 1^{st} cycle×100 Equation 1

Capacity retention ratio (%)=[Discharge capacity of 100^{th} cycle (or 300^{th} cycle)/Discharge capacity of 1^{st} cycle]×100 Equation 2

The results of the initial formation efficiency and lifetime evaluation are shown in Table 1 below.

TABLE 1

| | Slurry used | Initial | Lifetime | |
|---|---|---|---|---|
| | to prepare | formation | (@100 | Lifetime |
| | electrode | efficiency [%] | cycle) | (@300 cycle) |
| Example 1 | Slurry 1 | 93% | 89% | 72% |
| Example 2 | Slurry 2 | 92% | 87% | 68% |
| Example 3 | Slurry 3 | 82% | 79% | 52% |
| Comparative | Comparative | 95% | 73% | 45% |
| Example 1 | slurry 1 | | | |
| Comparative | Comparative | 68% | — | — |
| Example 2 | slurry 2 | | | |

Referring to the evaluation results of Table 1, the initial formation efficiency was found to be higher when slurries with a larger content of the epoxy-phenolic resin composition than the rubber-based resin composition were used. This is attributed to the adhesion of the binder to the active material and current collector and the tensile strength of the binder serving as significant factors affecting the initial formation efficiency.

Referring to Table 1, the lithium battery of Comparative Example 1 was found to be slightly higher in initial formation efficiency as compared with the lithium secondary batteries of Examples 1 to 3, but to have a relatively shorter lifetime. This indicates that, as described above, the initial formation efficiency of a lithium battery is related to the tensile strength and the adhesion of the binder to the active material and current collector, while lifetime of the lithium battery over which repeated contractions and expansions of the active material occur is closely connected with elasticity of the binder.

Referring to Table 1, the lithium battery of Example 1 was found to have a higher initial formation efficiency and a longer lifetime as compared with the lithium battery of Example 2. This is attributed to a relatively low epoxy equivalent weight of the bisphenol-A novolac epoxy resin used in Example 1, which means the inclusion of relatively more epoxy groups, facilitating cross-linking during a thermal curing reaction, so that the lithium battery of Example 1 has improved tensile strength, and improved adhesion due to hydroxyl groups generated from the thermal curing reaction.

Referring to Table 1, the lithium battery of Comparative Example 2 manufactured from the comparative slurry 2, which was prepared using only the rubber-based resin composition, was found to have a very low initial formation efficiency as described above. Moreover, the lifetime of the lithium battery of Comparative Example 2 was so sharply reduced that it was not measurable even before 100 cycles. This indicates that adhesion and tensile strength of the anode are required in terms of the lifetime of the lithium battery.

As described above, according to the one or more of the above embodiments of the present invention, a binder for an electrode of a lithium battery may prevent deformation of an electrode even when expansion and contraction of an active material occur from charging and discharging operations of a lithium battery, and thus may improve the lifetime of the lithium battery.

It should be understood that the exemplary embodiments described herein should be considered in a descriptive sense only and not for purposes of limitation. Descriptions of features or aspects within each embodiment should typically be considered as available for other similar features or aspects in other embodiments that may be constructed according to the principles of the present invention.

What is claimed is:

1. A binder for an electrode of a lithium battery, the binder comprising an epoxy-phenolic resin and a rubber-based resin.

2. The binder for an electrode of a lithium battery of claim 1, wherein an amount of the rubber-based resin is from about 1 part by weight to about 300 parts by weight based on 100 parts by weight of the epoxy-phenolic resin.

3. The binder for an electrode of a lithium battery of claim 1, wherein the epoxy-phenolic resin comprises an epoxy-based resin, a multi-functional phenolic resin, and a curing agent.

4. The binder for an electrode of a lithium battery of claim 3, wherein the epoxy-based resin comprises at least one selected from the group consisting of bisphenol-A epoxy resin, bisphenol F epoxy resin, bisphenol S epoxy resin, bisphenol P epoxy resin, phenolic novolac epoxy resin, cresol novolac epoxy resin, bisphenol-A novolac epoxy resin, bisphenol F novolac epoxy resin, phenolic salicylaldehyde novolac epoxy resin, alicyclic epoxy resin, aliphatic chain epoxy resin, glycidyl ester epoxy resin, a glycidyl-etherification product of bifunctional phenol, a glycidyl-etherification product of bifunctional alcohol, a glycidyl-etherification product of polyphenol, and a modified resin thereof.

5. The binder for an electrode of a lithium battery of claim 3, wherein the multi-functional phenolic resin comprises at least one selected from the group consisting of bisphenol F, bisphenol-A, bisphenol S, polyvinyl phenol, phenol, cresol, alkyl phenol, catechol, novolac resin, and a halide substitution product thereof.

6. The binder for an electrode of a lithium battery of claim 3, wherein at least one of the epoxy-based resin and the multi-functional phenolic resin further comprises a carboxyl group.

7. The binder for an electrode of a lithium battery of claim 3, wherein the multi-functional phenolic resin has a hydroxyl equivalent weight of from about 50 to about 1000.

8. The binder for an electrode of a lithium battery of claim 3, wherein the curing agent comprises at least one selected from the group consisting of an alkali metal compound, an alkali earth metal compound, an imidazole compound, an organic phosphorous compound, and an amine-based compound.

9. The binder for an electrode of a lithium battery of claim 1, wherein the epoxy-phenolic resin has an epoxy equivalent weight of from about 100 to about 2000.

10. The binder for an electrode of a lithium battery of claim 1, wherein an amount of the multi-functional phenolic resin is from about 1 part to about 300 parts by weight, and an amount of the curing agent is from about 0.01 parts to about 20 parts by weight, each based on 100 parts by weight of the epoxy-based resin.

11. The binder for an electrode of a lithium battery of claim 1, wherein the rubber-based resin further comprises a cross-linking agent.

12. The binder for an electrode of a lithium battery of claim 11, wherein an amount of the cross-linking agent is from about 0.01 parts by weight to about 30 parts by weight based on 100 parts by weight of the rubber-based resin.

13. The binder for an electrode of a lithium battery of claim 11, wherein the cross-linking agent are sulfur, organo-sulfur, peroxide, an amine-based compound, or combinations thereof.

14. The binder for an electrode of a lithium battery of claim 13, wherein the peroxide comprises at least one selected from the group consisting of benzoyl peroxide, 2,4-dichlorobenzoylperoxide, p-chlorobenzoyl peroxide, dicumylperoxide, di-t-butyl peroxide, 2,5-dimethyl-2,5-di-t-butylhexane peroxide, t-butylcumyl peroxide, and combinations thereof.

15. The binder for an electrode of a lithium battery of claim 1, wherein the rubber-based resin comprises at least one selected from the group consisting of natural rubber, butadiene rubber, styrene-butadiene rubber, chloroprene rubber, nitrile rubber, butyl rubber, ethylene-propylene rubber, acryl rubber, urethane rubber, fluororubber, a modified rubber thereof, and combinations thereof.

16. The binder for an electrode of a lithium battery of claim 15, wherein the modified rubber of butadiene rubber comprises at least one selected from the group consisting of epoxy-modified butadiene rubber, urethane-modified butadiene rubber, acrylonitrile-modified butadiene rubber, carboxyl group-containing butadiene rubber, carboxyl group-containing methacrylonitrile butadiene rubber, acryl group-containing butadiene rubber, hydroxyl group-containing butadiene rubber, and combinations thereof.

17. The binder for an electrode of a lithium battery of claim 1, wherein the binder is used in forming an anode of a lithium battery.

18. An electrode for a lithium battery, the electrode comprising the binder of claim 1.

19. A lithium battery comprising:
an anode;
a cathode disposed opposite to the anode; and
an electrolyte disposed between the anode and the cathode, wherein
at least one of the anode and the cathode comprises the binder of claim 1.

20. The lithium battery of claim 19, wherein the anode comprises at least one anode active material selected from among a silicon-based active material, a tin-based active material, a silicon-tin alloy-based active material, a silicon-carbon-based active material, and a graphite-based active material.
